(19) United States
(12) Patent Application Publication
(10) Pub. No.: US 2012/0232857 A1
(43) Pub. Date: Sep. 13, 2012

(54) INDIVIDUALLY TAILORED SOFT COMPONENTS

(75) Inventors: Rune Fisker, Virum (DK); Ialn McLeod, Fredensborg (DK)

(73) Assignee: 3SHAPE A/S, Copenhagen K (DK)

(21) Appl. No.: 13/502,296

(22) PCT Filed: Oct. 6, 2010
(86) PCT No.: PCT/DK10/50256

§ 371 Date: May 22, 2012

Related U.S. Application Data
(60) Provisional application No. 61/252,222, filed on Oct. 16, 2009.

(51) Int. Cl. G06F 17/50

(52) U.S. Cl. 703/1

(57) ABSTRACT

A computer-implemented method for creating a customized CAD model of a casting mold, defined as the casting mold CAD model, for moulding of a personalized device, where the casting mold is used for casting an at least partly soft mould as part of the personalized device, and where the casting mold is adapted to be manufactured by means of rapid prototyping, such as 3D printing, including the steps of: —acquiring an input 3D model representing the personalized device, where the input 3D model is acquired by means of 3D scanning, —generating the casting mold CAD model as an impression of at least a part of the input 3D model, said casting mold CAD model thereby including the negative geometry of the personalized device, and—defining at least one sectioning of the casting mold CAD model by means of at least one separation plane and/or separation spline.

The present invention relates to design and manufacture of customized components and/or devices, in particular soft components/devices, for example components for soft ear molds.

### BACKGROUND OF INVENTION

Individually tailored personal products are known in the art, low-tech as well as high-tech products. Examples are shoes, jewelry, hearing aid devices, dental restorations and the like. The mentioned examples are products that are more or less customized to an anatomical part of an individual to provide the best possible fit. This customization requires some sort of mapping of the individual, or at least a mapping of the specific body part. A detailed mapping may be provided by direct scanning or by use of impressions. Impressions are widely used within dental restorative work and hearing aid technology.

When a mapping of the individual, e.g. the mapping of an ear, has been provided methods and processes are known in the art to design and manufacture individually customized devices, e.g. by means of CAD/CAM technology where the single components of the device (or a prototype of the device) can be designed and manufactured for optimal fit to the individual. However, this applies mostly to hard components (or prototype components) that can be directly manufactured by CAM technology.

An ear mold (or ear mould or earmold or earmould) is a device worn inserted into the ear for sound conduction or ear protection. When used in hearing aid devices (in particular behind-the-ear (BTE) hearing aids) the ear mold is used as a conductor thereby improving the sound transmission to the eardrum. For best fit ear molds can be anatomically shaped to the ear and the ear canal. For general use ear molds can be produced in different sizes. Ear molds can be made in hard or soft materials, however soft materials naturally provide most comfort for the user.

JP2006197145 discloses an ear-hole mounting element manufacturing method e.g. for an ear plug, which produces shape data by measuring the shape of the ear-hole in different states. The ear-hole shapes (1,2) in different states are measured and an ear-hole shape data (6,7) are generated. A shape data (10) is generated by a computer (8) using the acquired ear-hole shape data. The shape data produced by the computer is sent to a numerical control modeling machine (11) for manufacturing the ear-hole mounting element (25). The mounting state of the element is maintained in a favorable position even when the shape of ear-hole changes.

KR20090092519 discloses a manufacturing method of a hearing aid shell comprising: a step of taking an impression of ear using silicone; a step of scanning the ear impression; a step of designing the hearing aid shell using software; a step of outputting the hearing aid shell using a rapid prototyping equipment; and a step of assembling electronic components and the hearing aid shell and managing the quality. The step of scanning ear impression uses a three-dimensional scanner in consideration of complexity and diversity of ear-shape.

US2004026163A discloses a method for manufacturing ear devices with at least one venting passage extending essentially substantially over the length of said ear plug device between regions respectively facing the ear drum and the outer ear environment comprising the steps of: providing data including a three-dimensional shape of said venting passage; construing parts for said ear devices by respectively depositing commonly a layer of one of a liquid and of a powderous material and solidifying by a laser arrangement in said layer individually shaped layers of said parts, thereby controlling said laser arrangement with said data to solidify in said layers respectively a contour of a cross-section of said venting passage. According to one embodiment an ear device is made flextural or compressible in a predetermined region. The shell of the ear device, in particular that of an in-ear hearing aid, for that purpose, is fitted in one or more predetermined areas with a corrugated or accordion-like bellows structure, where bendability or compressability are required.

WO02071794A discloses a method for computer-assisted modelling of customised earpieces comprising at least one part being individually matched to an auditory canal and/or a meatus, said method comprising the steps of: a) obtaining a three-dimensional computer model, 3D-model, of at least part of the auditory canal, said 3D-model having an outer surface, b) initially arranging at least one component in relation to the 3D-model, c) initially arranging a cutting curve or cutting surface in relation to the outer surface of the 3D-model, said cutting curve or surface dividing the 3D-model in an outer portion and an inner portion, d) initially forming a connecting surface connecting the at least one component and the inner portion of the 3D-model, said connecting surface thereby being part of the 3D-model, e) performing an evaluation of the arrangement of the at least one component, said evaluation comprising a collision detection of the at least one component-in relation to one or more parts of the 3D-model and/or other components, and f) adjusting the arrangement of the at least one component, the arrangement of the cutting curve or surface, and/or the formation of the connecting surface based on the result of said evaluation. According to one embodiment different materials are assigned to different parts of the model taking the location of hard and soft parts of the auditory canal and/or concha and/or meatus into consideration.

US2006239481A discloses a method for producing a casting mold for a hearing device component, comprising the steps of: providing CAD data representing a three-dimensional shape of a hearing device component; forming negative data with respect to the shape of said hearing device component; and casting a negative mold of said hearing device component from said negative data using a rapid prototyping technique.

### SUMMARY OF INVENTION

One object of the invention is to be able to efficiently manufacture customized soft component for personal devices.

This is achieved by a computer-implemented method for creating a customized CAD model of a casting mold, defined as the casting mold CAD model, for moulding of a personalized device, where the casting mold is used for casting an at least partly soft mould as part of the personalized device, and where the casting mold is adapted to be manufactured by means of rapid prototyping, such as 3D printing, said method comprising the steps of:
acquiring an input 3D model representing the personalized device, where the input 3D model is acquired by means of 3D scanning,
generating the casting mold CAD model as an impression of at least a part of the input 3D model, said casting mold CAD model thereby comprising the negative geometry of the personalized device, and
defining at least one sectioning of the casting mold CAD model by means of at least one separation plane and/or separation spline.

In the preferred embodiment of the invention the personalized device is shaped and/or tailored to fit an anatomic part of person. This would be the case if the personalized device was a BTE hearing aid device for a person and the component was the corresponding ear mold, i.e. the ear mold is shaped to fit the ear canal of the person.

The personalized device could also be a shell type hearing device comprising a soft mold part, where the hearing device can be of the type receiver-in-the-canal (RIC), in-the-ear (ITE), in-the-canal (ITC), completely-in-the-canal (CIC), invisible-in-the-canal (IIC) etc.

Thus, with the present invention a CAD process can be applied to design and produce a soft mold of soft shell for the application of a hearing device or aid by utilizing a manual and/or automatic set of computations within a software application to generate a casting mold for pouring or injection molding. One embodiment of the invention therefore discloses a way to design and manufacture individually tailored soft ear molds.

Manufacturing of soft molds may be produced by means of casting because it may not be possible to manufacture a soft mold, of e.g. silicone, by means of 3D printing. Thus the present invention may be used for manufacturing molds which cannot be produced by other techniques, e.g. 3D printing.

A personalized device such as an ear mold may comprise both a hard part and a soft part, thus a personalized device may consist of only a soft part or comprise a combination of hard and soft parts.

Soft may be defined as yielding to physical pressure, unduly susceptible to influence, compliant etc.

The input 3D model is preferably the starting point in the process of designing a casting mold, because the input 3D model is the model representing the personalized device. Thus, one object of the present invention is to provide the means and the methods to provide an actual physical replica of the input 3D model or at least a part of said 3D model.

It is an advantage that the method is computer-implemented instead of performed by handicraft, since if using handicraft, it is not possible to make some very small components, parts or features in the mold, but this is possible when using a computer-implemented method. Very small features may for example be necessary when creating a hearing device with a mold or shell for children having very small ears.

Furthermore, the quality and/or the manufacturability which is obtained by handicraft may not be good enough for personalized device, such as hearing devices, where the fit or complexity of the device is very important. In these cases a computer-implemented method should be used for achieving a satisfactory result.

Another advantage of using a computer-implemented method is that it reduces the soft material consumption as there is no wastage. Some of the materials which are used for producing e.g. ear molds for hearing devices are very expensive, and therefore it is very desirable to use as little material as possible, and even e.g. 5% less material used can be very advantageous financially speaking. When using a computer-implemented method of creating an ear mold no material will be discharged, but when manufacturing an ear mold by handicraft for example tubes for creation of vent channels must be drilled away afterwards from the manufactured ear mold, and then this possibly very expensive ear mold material will be non-reusable.

Different cast styles can be used when manufacturing a casting mold CAD model for e.g. an ear mold, such as:
an open-cup cast which is a simple reusable design for pouring custom soft molds when a complex outer surface is not required;
an enclosed cast which is a fully enclosed design producing no join lines.

This cast cannot be reused since it is broken open. But it is cost effective due to its small printing foot-print and minimal material usage and post processing need;
an assembly cast, which is a reusable design allowing for complicated parts, but which may use more material due to the assembly structure. Also, the final product may require some amount of post-processing to remove excess material along the join lines.

The input 3D model may be provided directly as input data to the design and manufacturing process, e.g. by means of a ready to use CAD model. However, as one object of the invention concerns a personalized device shaped to fit an anatomic part of a person, a further embodiment of the invention comprises means for acquiring one or more 3D models of at least a part of said anatomic part, and/or an impression of said anatomic part. The input 3D model is then preferably based on said one or more 3D models. Further, said one or more 3D models can be provided by 3D scanning said anatomic part and/or by 3D scanning an impression of said anatomic part. 3D scanners are known in the art.

In one particular embodiment of the invention the personalized device is a soft ear mold, the anatomic part is the human ear and the 3D model is a model of the human ear and/or the human ear canal and/or a model of an impression of the human ear and/or the human ear canal.

As the manufactured soft product is individually tailored the corresponding casting mold may be seen as a disposable casting mold. With the progress in technology and the future expected cost reduction within 3D printing technology individually tailored and disposable casting molds makes sense. As 3D printing may be a standard home application in the future the herein disclosed methods and systems regarding design and manufacture of casting molds may be widely applied, e.g. to toys, various tools, design objects, kitchen and home appliances, jewelry, ornamentation and/or the like. Actual 3D printing is limited in the material selection but casting molds and in particular disposable casting molds may open a new range of materials, e.g. silicone that may be applied in the molding process. The present invention is therefore in some way the optimization and modernization of the ancient art of moldmaking.

### DEFINITIONS

### Casting

Casting is a manufacturing process by which a liquid material, such as plastic, glass, metal, silicone or ceramic, is usually poured into a mold and then allowed to solidify. The mold contains a hollow cavity of the desired shape. The liquid hardens or sets inside the mold, adopting its shape. The solidified part is also known as a casting, which is ejected or broken out of the mold to complete the process. Casting materials are usually metals or various cold setting materials that cure after mixing two or more components together; examples are epoxy, concrete, plaster and clay. Casting is most often used for making complex shapes that would be otherwise difficult or uneconomical to make by other methods.

### Molding

Molding or moulding is the process of manufacturing by shaping pliable raw material using a rigid frame or model, thus a mold can be a hollowed-out block. A mold is the opposite of a cast.

In the literature and in this application the terms “molding process” and “casting process” may be used in the same meaning. As an example “injection molding” is actually a casting process.

In this application the “casting mold” is the physical realisation of the “casting mold CAD model”. The casting mold can for example be manufactured on a 3D printer based on the digital input from the casting mold CAD model.

### Ear Mold

Contrary to the cast-mold terminology an ear mold (or ear mould or earmold or earmould) is a device worn inserted into the ear for ear protection or sound conduction (in a hearing aid device). All BTE (behind the ear) and body hearing aids need a separate ear mold. The ear mold helps to ensure that the hearing aid rests securely on the ear. A well-fitting ear mold helps prevent feedback whistling from the hearing aid by preventing sound leakage. The ear mold must therefore fit tightly in the ear, thus ear molds need to be custom-made for the hearing aid user. An ear mold can be manufactured from an impression cast to be an exact replica of the shape of the ear. Thus, an ear mold is not a mold in the normal meaning of the word mold. On the contrary an ear mold may be the result of a casting process, such as injection molding. When used in hearing aid devices (in particular behind-the-ear hearing aids) the ear mold is used as a conductor thereby improving the sound transmission to the eardrum. For best fit ear molds can be anatomically shaped to the ear and the ear canal. For general use ear molds can be produced in different sizes. Ear molds can be made in hard or soft materials, however soft materials naturally provide most comfort for the user. It is not uncommon for children to need a new ear mold every 6 months or so because as the child grows, the ear mold doesn't fit tightly any longer. The present invention discloses a way to produce individually tailored soft ear molds.

### Occlusion Effect

The occlusion effect occurs when an object fills the outer portion of a person's ear canal, and that person perceives “hollow” or “booming” echo-like sounds of their own voice because bone-conducted sound vibrations are reverberating off the object filling the ear canal. When talking or chewing, these vibrations normally escape through an open ear canal and when the ear canal is blocked, the vibrations are reflected back toward the eardrum.

### 3D Printing

3D printing is an additive manufacturing technology where a 3D object is created by successive layers of material. 3D printers are generally faster, more affordable and easier to use than other additive manufacturing technologies. 3D printers are most frequently used for prototyping.

### DETAILED DESCRIPTION OF THE INVENTION

The final casting mold must be an accurate negative replica of the personalized device. This is provided by digitally provide an “impression” of the input 3D model and integrating this impression into the casting mold CAD model which thereby comprises the negative geometry of the personalized device. Thus, the generation of a casting mold CAD model comprises the step of providing a negative impression of the input 3D model.

Further, a casting mold may comprise several parts that can be assembled like a puzzle in the molding process and taken apart again when the molding process is completed. Thus, the casting mold CAD model creation also comprises the step of determining the single parts of the casting mold CAD model, i.e. the separation of the casting mold CAD model into two or more mold sections. This separation may preferably be specified on the input 3D model, because the shape of the input 3D model provides a good indication on where the separation is most optimally located. Thus, the casting mold CAD model creation further comprises the step of arranging at least one separation plane/curve/spline on the input 3D model. This arranging may be provided by a manual operation of the CAD user and/or by automatic arrangement, for example based on one or more algorithms for a best fit. The arrangement of a separation plane and/or separation spline can also be provided to remove undercuts.

In some embodiments the method further comprises the step of providing an interlocking mechanism of the casting mold CAD model. The casting mold CAD model may provide some sort of interlocking and/or lock-and-hold mechanism to make sure that the different parts of the casting mold fit together in a unique way and to allow for tight coupling of the assembled casting mold. The interlocking mechanism of the casting mold CAD model is not necessarily a lock in the strict interpretation of the word. The interlocking mechanism however preferably provides some kind of assembling guide, e.g. a guide to assembling the puzzle in an unequivocal way. This guide may be provided e.g. by means including one or more interlocking pins and/or one or more connector strands in the casting mold CAD model.

In some embodiments the at least one interlocking pin and/or the at least one connector strand is provided in the casting mold CAD model.

To further assist the user in the CAD design process a casting mold CAD model can be based on a template, i.e. a the casting mold CAD model is generated from a template casting mold CAD model. The template may be a predefined template. A template is an at least partly predefined CAD model. Thus, for example a casting mold CAD model may be generated from a template CAD model based on a plurality of configuration parameters. The template casting mold CAD model may e.g. comprise one or more single geometry templates and/or a plurality of interlocking geometry section models that when printed on a 3D printer can assemble to an enclosed casting mold. Thus, in a particular straightforward design process a template casting mold CAD model is selected and after applying the negative geometry of the input 3D model to the template casting mold CAD model the casting mold CAD model may be ready to print.

However, the actual generation of a template casting mold CAD model may not be necessary. In one embodiment of the invention the casting mold CAD model itself is generated from a plurality of configuration parameters.

The configuration parameters of a casting mold CAD model and/or a template casting mold CAD model are selected from one or more of the following parameters:
number of interlocking sections,
type of casting mold housing, such as open or enclosed casting mold, see e.g. FIGS. 6 and 8,
the width of the wall of the casting mold,
configuration of interlocking mechanism,
number, dimension and location of leg stanchions for the casting mold,
type and location of one or more identification elements,
dimension and orientation of connector strand(s) between casting mold sections,
dimension of locking mechanism(s) between casting mold sections.

A casting mold CAD model may further be individualized by applying some kind of identification means. Thus, a further embodiment of the invention comprises means for defining and positioning at least one embossed or engraved etched identification element on the surface of the casting mold CAD model, an identification (ID) element such as an ID tag. Each section of the casting mold CAD model may be provided with an ID element. This may further assist and guide the assembly of the different casting mold sections in the assembly phase of the molding process. One or more ID tags placed inside or outside on the surface of the casting mold may also provide visual and/or automatic identification of the produced part, e.g. within the context of a production order.

Thus, in some embodiments the identification element is arranged on the inside surface of the casting mold, such that the identification element will also be present on the personalized device.

In some embodiments the identification element is arranged on the outside surface of the casting mold, such that the identification element can be used when assembling more casting mold sections.

Even if the casting mold is provided in several separate sections it may be necessary to further break the casting mold apart after the molding process to extract the device from the casting mold. A further embodiment of the invention therefore comprises means for defining and positioning at least one surface area on the casting mold CAD model by means of lines, splines and/or planes, said at least one surface area adapted to act as breakage point(s) when extracting the device subsequent to the casting process. These surface areas may be realised as weak and/or fragile spots or lines on the printed casting mold which is supposed to break in the weak and/or fragile spots or along the weak and/or fragile lines when pressure is applied (e.g. merely by hand) to the casting mold.

The molding process necessarily comprises the step of adding material to the casting mold. The molding material may be arranged in one or more of the different sections of the casting mold prior to assembly and/or the molding material may be added to the closed casting mold. Further, an abundance of molding material may have been added to the casting mold in the molding. A further embodiment of the invention therefore comprises means for defining and positioning at least one injection point in the casting mold CAD model, said at least one injection point being adapted for pouring and/or injection of soft material in the casting process. Further, means for defining and positioning at least one drainage hole in the casting mold CAD model may be comprised, said at least one drainage hole being adapted for the release of excess soft material during the casting process. Tap holes and/or injection points may be positioned in the casting mold CAD model merely by manually indicating points on the surface of said model, i.e. points where the tap holes/injection points have inlets and outlets. The completion of the tap holes and/or injection points may then be completed by means of pre-defined CAD models for such tap holes and/or injection points.

There can be multiple injection points and drainage holes or drains arranged in the cast.

A vent channel in an ear mold can reduce the sensation of a plugged up ear, or of speaking in a barrel. A further embodiment of the invention therefore comprises means for defining and positioning at least one vent channel in the casting mold CAD model.

It may be a good idea to keep the different sections of the casting mold together in the casting process. Thus, a further embodiment of the invention comprises means for defining and positioning at least one attachment section to a plurality of the casting mold CAD model sections, said attachment sections adapted to attach the casting mold CAD model sections to each other, said attachment sections preferably adapted to be breakable by hand.

The above mentioned identification element(s), injection point(s), drainage hole(s), vent channel(s), surface area(s) and/or attachment section(s) may be provided as one or more predefined CAD models. E.g. the attachment sections in itself is a predefined CAD model, e.g. selected from a database of CAD models and integrated with the casting mold CAD model. Further the above mentioned positioning and/or arrangements may be provided manually by a user of the CAD process or automatically by the CAD software, e.g. by pre-defined placement rules, or by a combination hereof.

As the casting mold typically will be manufactured on a 3D printer a further object of the invention is to minimize the amount/volume of material necessary for the casting mold CAD model, both to speed up the manufacturing process but also to be cost-effective in terms of used printing material. A further embodiment of the invention therefore comprises means for minimizing the amount/volume of necessary material for the casting mold CAD model. This may e.g. be provided as a last step in the CAD design process, i.e. when the casting mold CAD model is finished a further step may be to reduce the volume of essentially all parts of the model, either manually or automatically or a combination hereof.

Preferably the volume of the leg stanchions is reduced and/or minimized.

In some embodiments the casting mold CAD model is a casting shell CAD model comprising a trench into which soft material is adapted to be poured and a space holder for providing a hollow shell.

It is an advantage since due to the trench and the space holder, the resulting moulded part will be hollow. The soft material may be silicone, which provides a comfortable soft shell which may be used as a soft outer surface for a hearing device, and hard material may be arranged inside the soft shell e.g. for holding electronics etc. for the hearing device.

Furthermore, the casting shell CAD model may also comprise all the usual elements, such as a tube for creation of a vent channel as part of the shell.

Yet a further embodiment of the invention comprises means for scaling of the casting mold CAD model, such as scaling along the x-, y-, and/or z-axis, and/or uniform scaling of all parts.

A further object of the invention is to manufacture the actual realization of the personalized device (or merely a component thereof). This is achieved by a system for producing a soft cast for a personalized device, a device such as an ear mold for a hearing aid, said system comprising:
means for creating a casting mold CAD model according to the herein described system,
means for providing a casting mold based on said casting mold CAD model,
means for injecting and/or pouring soft material into the casting mold,
means for assembling the different sections of the casting mold, and
means for extracting the cast from the casting mold by:
   disassembling each interlocked cast section, and/or
   breaking the cast along one or more fragile lines.

Equivalently the invention further relates to a method for producing a soft cast for a personalized device, a device such as an ear mold hearing aid device, said method comprising the steps of:
designing a casting mold CAD model according to all the steps of any of the above described methods,
3D printing a casting mold based on said casting mold CAD model,
injection and/or pouring of soft material into the casting mold,
assembling the different sections of the casting mold containing the soft material thereby producing the soft cast, and
extracting the cast from the casting mold by:
   disassembling each interlocked cast section, and/or
   breaking the cast along one or more of the fragile lines.

In the actual process of producing the casting mold the order of assembly and injection may vary, i.e. the soft material, such as silicone, may be added (e.g. poured) before assembly of the casting mold sections or the soft material may be injected after the assembly of the casting mold. The casting mold can be realized by means of rapid prototyping. However, 3D printing is the preferred manufacturing process for the casting mold. A further embodiment of the invention comprises means for aligning the printing orientation of the casting mold manually or automatically or a combination hereof.

The invention further concerns a computer program product having a computer readable medium, said computer program product providing a system for creating a customized CAD model of a casting mold for molding of a personalized device, and said computer program product comprising means for carrying out all of the steps of any of the herein listed methods.

The present invention relates to different aspects including the method described above and in the following, and corresponding methods, devices, systems, uses, and/or product means, each yielding one or more of the benefits and advantages described in connection with the first mentioned aspect, and each having one or more embodiments corresponding to the embodiments described in connection with the first mentioned aspect and/or disclosed in the appended claims.

In particular, the invention further relates to a system for creating a customized CAD model of a casting mold, defined as the casting mold CAD model, for molding of a personalized device, where the casting mold is used for casting an at least partly soft mould as part of the personalized device, and where the casting mold is adapted to be manufactured by means of rapid prototyping, such as 3D printing, said system comprising:
means for acquiring an input 3D model representing the personalized device, where the input 3D model is acquired by means of 3D scanning, and
means for generating the casting mold CAD model comprising:
   an impression of the input 3D model, said casting mold CAD model thereby comprising the negative geometry of the personalized device, and
   at least one separation plane and/or separation spline defining the sectioning of the casting mold CAD model.

### DESCRIPTION OF DRAWINGS

The invention will be described in more detail with reference to the drawings, wherein

FIG. 1 is an illustrative view of some of the processes related to one embodiment of the present invention,

FIG. 2 shows an example of an input 3D model,

FIG. 3 illustrates a separation method of an input 3D model,

FIG. 4 is an example of one part of a casting mold CAD model,

FIG. 5 illustrates a break line applied to a casting mold CAD model,

FIG. 6 shows a casting mold CAD model with three interlocking parts and a small insert of the assembled casting mold CAD model,

FIG. 7 shows a casting mold CAD model from FIG. 6 with close-ups of connector strands between the mold sections,

FIG. 8 shows a casting mold CAD model with two interlocking parts,

FIG. 9 shows a casting mold CAD model with three interlocking parts,

FIG. 10 shows a close up view of a part of a casting mold CAD model along with the direction of the x- and z-axes,

FIG. 11 shows an assembled casting mold CAD model from FIG. 6, and

FIG. 12 illustrates a further separation method of an input 3D model.

FIG. 13 shows an example of a cast shell CAD model.

FIG. 14 shows an example of an enclosed type cast CAD model with injection point and drain.

### DETAILED DESCRIPTION OF THE DRAWINGS

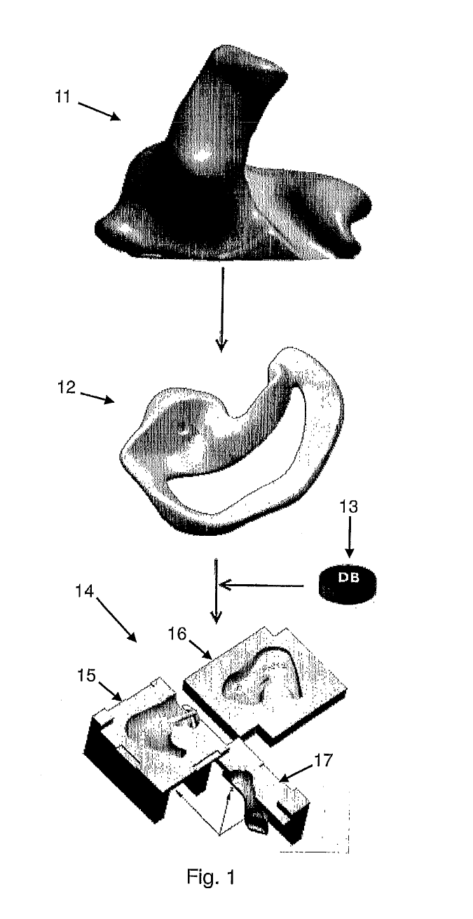

FIG. 1 illustrates an example of the CAD modelling software based process for creating a casting mold CAD model for a hearing aid device. A 3D model of an ear canal impression 11 is the basis for the design of the input 3D model 12, which is a BTE ear mold hearing aid device (or at least a part of it) individually designed to fit the ear represented by the 3D model 11. This part of the process is known in the art and usually a hard ear mold would be manufactured from the model 12, or possibly a 3D prototype of the model 12 could be manufactured on a 3D printer and a soft ear mold could be (manually) formed to resemble the model prototype. However, according to the present invention a casting mold CAD model 14 can be created “around” the input model 12. A casting mold corresponding to this casting mold CAD model 14 can then be manufactured, e.g. by means of rapid prototyping or by means of a 3D printer, and a soft ear mold that is an exact replica of the input model 12 can subsequently be provided in a casting process using the casting mold. The casting mold CAD model 14 can be designed with the optional input from a database 13 of predefined casting mold templates, templates which can be single geometry templates and/or a sequence of geometric sections with optional interlocking mechanisms in-between. The casting mold CAD model 14 comprises three sections 15, 16, 17 which when manufactured can be assembled in a unique way to a closed casting mold, i.e. just like a 3D puzzle or an assembly kit.

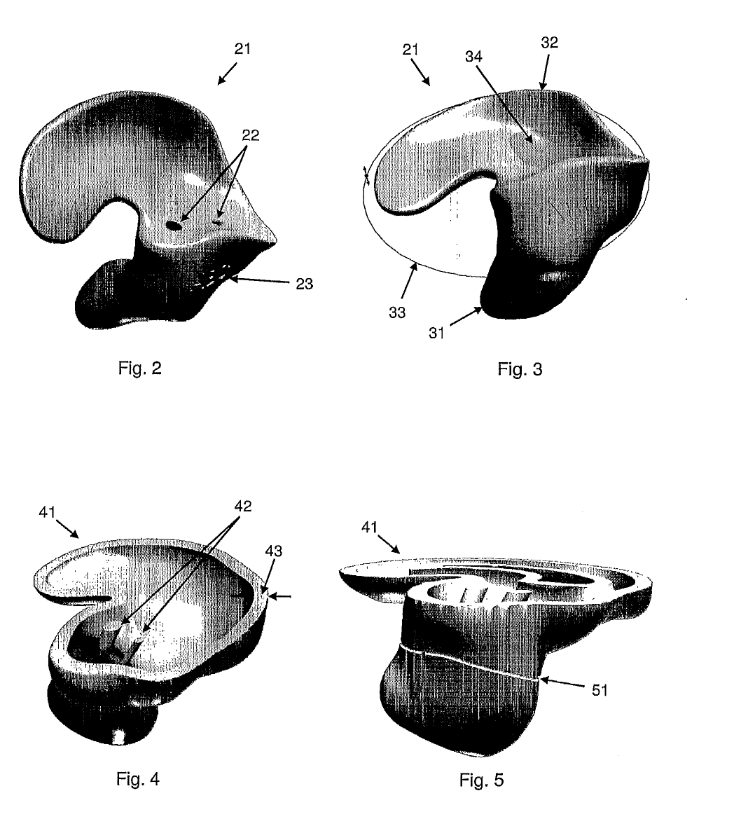

FIG. 2 illustrates an input 3D model 21 for a hearing aid with vent channels 22 and ID tag 23. In FIG. 3 a separation plane 33 is applied to the input 3D model 21 separating the model 21 into two parts: an inner part 31 and an outer part 32. This separation plane 33 also determines the separation of the casting mold which is supposed to be created to provide the physical realization of the input 3D model 21. The separation plane 33 may be arranged automatically to provide the most suitable separation of the input model 21 in terms of undercuts, etc. The separation plane 33 can preferably also be arranged by the user of the CAD software, i.e. the creator of the casting mold CAD model. The separation plane 33 may be edited in terms of e.g. position and angle. The separation plane 33 may preferably be edited at any time during the creation of the casting mold 3D model. The illustrated separation plane 33 is a 2D plane, however the separation of the input 3D model may be any curve or spline defining a separation of the input 3D model. The area 34 is a segment of the separation plane 33 which is visible because the separation plane cuts through the input model 21 at location of a depression in the input model 21. Thus, in a real casting mold CAD model design process the tilt and/or location of the separation plane 33 would be adjusted for practical purposes to avoid this segment 34 cutting through the input model 21.

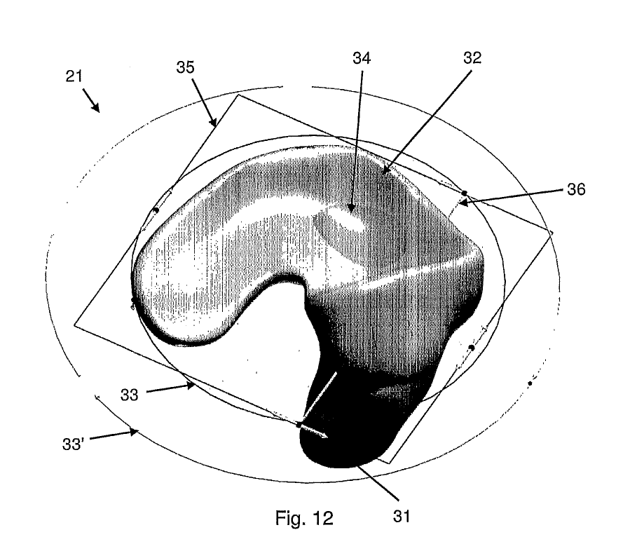

A more advanced separation method is illustrated in FIG. 12 which is almost equivalent to FIG. 3 with a separation plane 33 applied to the input 3D model 21. In this case a guide line 33′ is added to the separation plane 33 to more clearly illustrate the separation of the input model 21. A frame 35 is added to indicate the size of a corresponding casting mold CAD model, i.e. by changing the size of the frame 35 the size of the corresponding casting mold CAD model is changed correspondingly. The line 36 indicates a second separation of the input model 21 which is thereby separated in three parts. The corresponding casting mold CAD model then equivalently comprises three mold sections. A separation plane for the second separation along the line 36 is not indicated in the drawing, however the second separation of the input model 21 could for example be applied along a 2D plane substantially perpendicular to the separation plane 33 and along the line 36.

FIG. 4 shows a mold section 41 of the casting mold CAD model corresponding to the inner part 31 of the input model 21. The mold section 41 therefore comprises the negative geometry of the inner part 31 and the separation plane 33 determines the top opening surface for the mold section 41. The mold section 41 is part of a casting mold type that may be termed “open negative casting mold”. Tubes 42 for creation of the vent channels 22 are also visible. The width of the wall of the mold section 41 is indicated by arrows 43. This wall width 43 must be chosen as thin as possible to minimize the cost and the manufacturing time of the casting mold, however strong enough to sustain the molding process.

FIG. 5 is another perspective view of the mold section 41. A fragile line/curve 51 is visible. This fragile line/curve is designed into the CAD model to be a part of the mold section 41. The fragile line 51 will become a weak spot after the molding process, i.e. the casting mold will be easy to break along the fragile line 41 when the cast is to be separated from the casting mold.

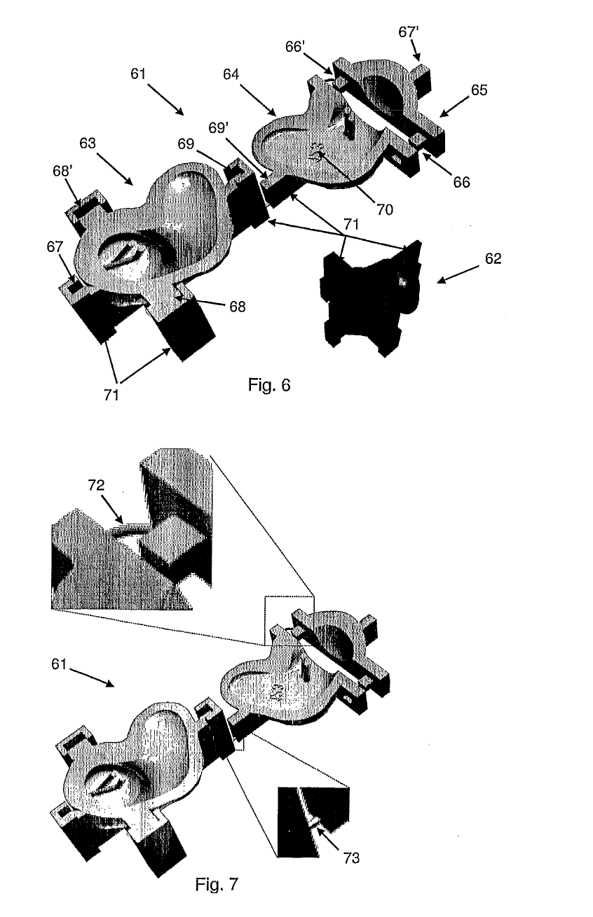

FIG. 6 shows a perspective view of a casting mold CAD model 61 according to an exemplary embodiment of the invention. The CAD model 61 comprises three mold sections 63, 64, 65 which fit together by means of interlocking mechanisms. Mold sections 64, 65 match together by means of the tongue and groove connections 66, 66′. Notch 67 matches 67′, notch 69 matches 69′, notch 68 matches the assembled connections 66 and correspondingly notch 68′ matches the assembled connection 66′ Thereby the open casting mold 3D model 61 can be assembled to the closed casting mold CAD model 62. Leg stanchions 71 are provided as a supporting structure and the interlocking mechanism are also part of the leg stanchions to enhance tight coupling of the assembled casting mould. The supporting structure may provide for a thinner casting mold wall and thereby use less material for the casting mold. The leg stanchions 71 further ensure that the assembled casting mold supports the application of pressure during the molding process. The negative impression of an ID tag 70 is also visible. FIG. 11 is a larger illustration of the closed casting mold CAD model 62.

FIG. 7 also shows casting mold CAD model 61 with close-ups of connector strands 72, 73 between the different mold sections 63, 64, 65. The connector strands 72, 73 may be breakable thereby simplifying assembly of the cast, because they provide a guide to the assembly. The casting mold may then be printed in one piece where the different mold sections 63, 64, 65 are bonded together by the connector strands. Thereby a single order (e.g. a single casting mold) may be kept together after printing. During the molding process the mold sections 63, 64, 65 are separated by breaking the connector strands 72, 73 whereupon the now separated casting mold sections 63, 64, 65 can be assembled to the closed casting mold 62. The connector strand 73 is a very simple connector strand merely providing a straight connector strand connection between the two mold sections 63, 64.

However, the connector strand 72 is bent in a semicircle. The reason is that a straight connector strand between the two mold sections 64, 65 would have to be located on the surfaces of the mold sections 64, 65 that are joined together. By placing a semicircle connector strand 73 on surfaces of the mold sections 64, 65 that are not joined together in the casting process a tight coupling between mold sections 64, 65 is ensured in the casting process because the joining surfaces are kept as flat and smooth as possible.

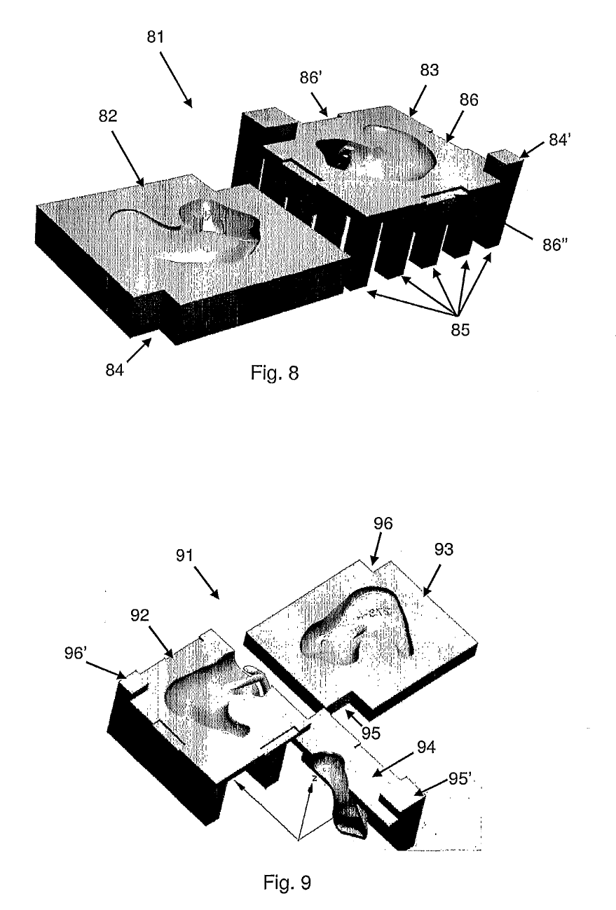

Yet another type of casting mold CAD model 81 is illustrated in FIG. 8 with two mold sections: An upper section 82 and a lower section 83. The separation plane applied to the corresponding input 3D model determines the separation plane between the two mold sections 82, 83, i.e. the upper surface of the mold sections 82, 83. The mold section 41 therefore comprises the negative geometry of the inner part 31 and the separation plane 33 determines the top opening surface for the mold section 41. The casting mold CAD model 81 is a casting mold type that may be termed “enclosed casting mold”.

Interlocking of the two sections 82, 83 can be provided by means of the matching corners 84, 84′. Indentations 86, 86′, 86″ are provided for easier separation of the two sections 82, 83 after the molding process. Leg stanchions 85 are provided as a supporting structure for the casting mold 81. The leg stanchions 85 provide use of less material for the casting mold 81 compared to a mostly solid cube. However, it is seen that even though leg stanchions 85 are provided the type of casting mold illustrated in FIG. 8 requires more material than the type illustrated in FIGS. 6 and 7. On the other hand, the casting mold type in FIG. 8 may be easier to design, because basic building blocks of the casting mold CAD model 81 may be provided from template casting mold CAD models.

A casting mold CAD model 91 with three interlocking mold sections 92, 93, 94 is illustrated in FIG. 9. The complex shape of the corresponding input model has necessitated the use of three mold sections to obtain a complete replica of the input model. Interlocking corners 95, 95′ match as well as the other two corners 96, 96′ fit together.

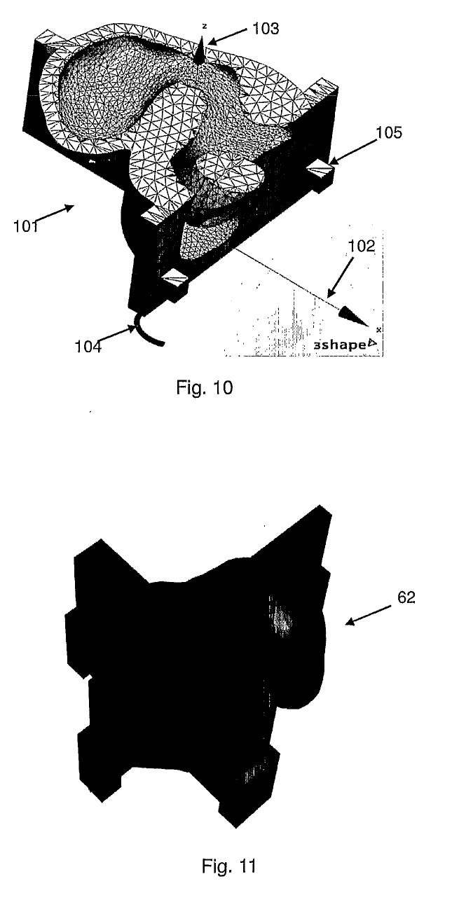

FIG. 10 shows a triangulated close up view of mold section 101 of a casting mold CAD model. In this illustration the preferred orientation of axes is indicated with the x-axis 102 and the z-axis 103 directions. A connector strand 104 and a part 105 of an interlocking mechanism are also visible.

In the preferred embodiment of the invention any change to the separation of the input model is instantly reflected and updated in the corresponding casting mold CAD model. I.e. the input 3D model and the casting mold CAD model are systematically interrelated.

When designing and creating a casting mold CAD model according to the invention the user of the CAD modelling software may be confronted with a plurality of configuration parameters that specifies the casting mold CAD model. Configuration parameters may be:
A number of separate interlocking cast sections
Separation method(s) of the input CAD model, defined as one or more planes or splines
Configuration of locking and holding mechanisms between cast sections
The width of the cast wall
Configuration of connectors between each separate cast section when printing the cast assembly
Scaling of the cast along the z-axis
Configuration of leg stanchions for each cast section to support the overall cast when assembled
ID tag placement on each section

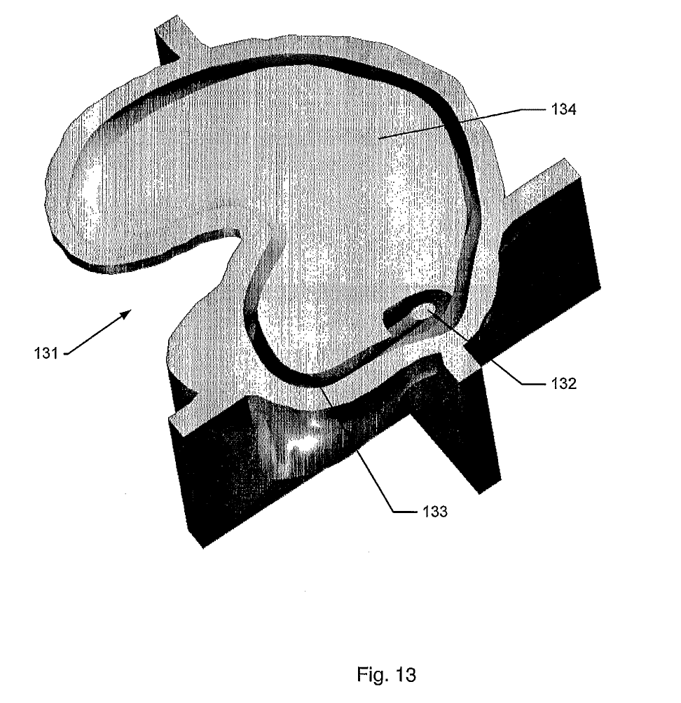

FIG. 13 shows an example of a cast shell CAD model.

The cast shell CAD model 131 comprises a trench 133 into which soft material, such as silicone, can be poured. This will result in a custom hollow shell instead of a more or less filled ear mould, because due to the trench 133 and the space holder 134 the resulting moulded part will be hollow. The CAD model 131 comprises a tube 132 for creation of a vent channel as part of the shell. The soft shell may be used as a soft outer surface for a hearing device, and hard material may be arranged inside the soft shell e.g. for holding electronics etc. for the hearing device.

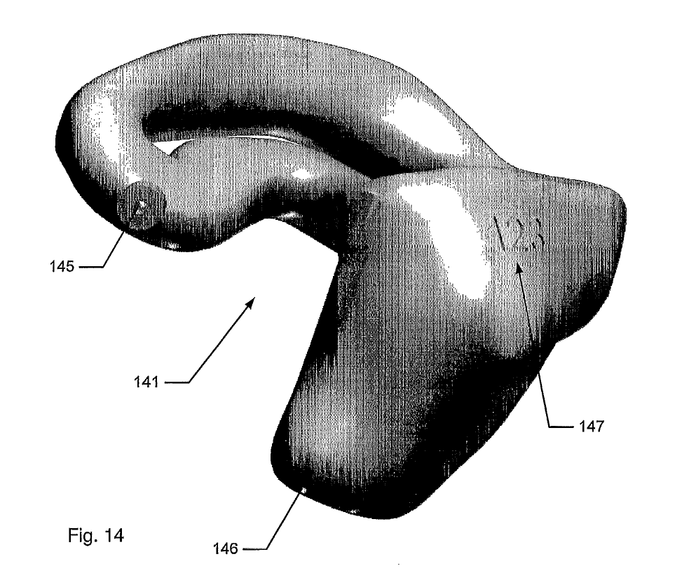

FIG. 14 shows an example of an enclosed type cast CAD model with injection point and drain.

The CAD model 141 comprises an injection point 145 and a drain 146 which is a little hole at the bottom of the CAD model 141. There can be multiple injection points 145 and drains 146 arranged in the cast.

The injection point 145 may first be defined and then positioned in the casting mold CAD model 141, and the injection point 145 is adapted for pouring and/or injection of soft material in the casting process. The drain or drainage hole 146 may first be defined and then positioned in the casting mold CAD model 141, and the drainage hole 146 is adapted for the release of excess soft material during the casting process. Drainage holes 146 and injection points 145 may be positioned in the casting mold CAD model by manually indicating points on the surface of the model 141, i.e. the points where the drainage holes 146 and the injection points 145 have inlets and outlets. The completion of the drainage holes 146 and injection points 145 may then be completed by means of pre-defined CAD models for such drainage holes 146 and injection points 145.

There can be multiple injection points 145 and drainage holes or drains 146 arranged in the cast.

Furthermore, the casting mold CAD model 141 has been individualized by applying an identification (ID) element 147 which is the numbers “123”. The ID element 147 has been defined and positioned as an embossed or engraved etched identification element on the outside surface of the casting mold CAD model 141. Each section of the casting mold CAD model 141 may be provided with an ID element 147. One or more ID tags placed inside or outside on the surface of the casting mold may also provide visual and/or automatic identification of the produced part, e.g. within the context of a production order.

In this case the identification element 147 is arranged on the outside surface of the casting mold, such that the identification element can be used when assembling more casting mold sections.

In other cases the identification element 147 can be arranged on the inside surface of the casting mold, such that the identification element will also be present on the personalized device after casting.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

The features of the method described above and in the following may be implemented in software and carried out on a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

1-36. (canceled)

37. A computer-implemented method for creating a customized CAD model of a casting mold, defined as the casting mold CAD model, for moulding of a personalized device, where the casting mold is used for casting an at least partly soft mould as part of the personalized device, and where the casting mold is adapted to be manufactured by means of rapid prototyping, such as 3D printing, said method comprising the steps of:
acquiring an input 3D model representing the personalized device, where the input 3D model is acquired by means of 3D scanning,
generating the casting mold CAD model as an impression of at least a part of the input 3D model, said casting mold CAD model thereby comprising the negative geometry of the personalized device, and
defining at least one sectioning of the casting mold CAD model by means of at least one separation plane and/or separation spline.

38. A method according to claim 37, further comprising the step of providing an interlocking mechanism of the casting mold CAD model.

39. A method according to claim 37, wherein the personalized device is shaped to fit an anatomic part of person.

40. A method according to claim 37, further comprising the step of acquiring one or more 3D models of
at least a part of said anatomic part, and/or
an impression of said anatomic part, and
wherein the input 3D model is based on said one or more 3D-models.

41. A method according to claim 40, wherein said one or more 3D models are provided by 3D scanning said anatomic part and/or by 3D scanning an impression of said anatomic part.

42. A method according to claim 37, wherein said at least one separation plane and/or separation spline is defined at the input 3D model.

43. A method according to claim 37, further comprising the step of automatically arranging said at least one separation plane and/or separation spline, preferably based on one or more algorithms for a best fit.

44. A method according to claim 37, wherein said at least one separation plane and/or separation spline is arranged to remove undercuts.

45. A method according to claim 37, further comprising the step of selecting and/or generating one or more template casting mold CAD models.

46. A method according to claim 37, wherein the casting mold CAD model is generated from a template CAD model.

47. A method according to claim 37, wherein the casting mold CAD model and/or the template casting mold CAD model comprises a plurality of interlocking geometry section models that are adapted to assemble to an enclosed casting mold model.

48. A method according to claim 37, wherein the personalized device is a soft ear mold, the anatomic part is the human ear and the 3D model is a model of the human ear and/or the human ear canal and/or a model of an impression of the human ear and/or the human ear canal.

49. A method according to claim 37, wherein the casting mold CAD model and/or the template casting mold CAD model is defined by means of a plurality of configuration parameters, and where the configuration parameters of a casting mold CAD model and/or a template casting mold CAD model are selected from one or more of the following parameters:
number of interlocking sections,
type of casting mold housing, such as open or enclosed casting mold,
the width of the wall of the casting mold,
configuration of interlocking mechanism,
number, dimension and location of leg stanchions for the casting mold,
type and location of one or more identification elements,
connector strand dimensions between casting mold sections,
locking mechanism dimensions between casting mold sections.

50. A method according to claim 37, further comprising the step of defining and positioning at least one injection point in the casting mold CAD model, said at least one injection point being adapted for pouring and/or injection of soft material in the casting process.

51. A method according to claim 37, further comprising the step of defining and positioning at least one drainage hole in the casting mold CAD model, said at least one drainage hole being adapted for the release of excess soft material during the casting process.

52. A method according to claim 50, wherein said positioning is provided manually or automatically or as a combination hereof.

53. A method according to claim 37, further comprising the step of minimizing the amount and/or volume of necessary material for the casting mold CAD model.

54. A method for producing a soft cast for a personalized device, a device such as an ear mold hearing aid device, said method comprising the steps of:
designing a casting mold CAD model according to claims 37,
3D printing a casting mold based on said casting mold CAD model,
injection and/or pouring of soft material into the casting mold,
assembling the different sections of the casting mold containing the soft material thereby producing the soft cast, and
extracting the cast from the casting mold by:
disassembling each interlocked cast section, and/or
breaking the cast along one or more of the fragile lines.

55. A computer program product having a computer readable medium, said computer program product providing a system for creating a customized CAD model of a casting mold for molding of a personalized device, and said computer program product comprising means for carrying out all of the steps of the method according to claim 37.

56. A system for creating a customized CAD model of a casting mold, defined as the casting mold CAD model, for molding of a personalized device, where the casting mold is used for casting an at least partly soft mould as part of the personalized device, and where the casting mold is adapted to be manufactured by means of rapid prototyping, such as 3D printing, said system comprising:
means for acquiring an input 3D model representing the personalized device, where the input 3D model is acquired by means of 3D scanning, and
means for generating the casting mold CAD model comprising:
an impression of the input 3D model, said casting mold CAD model thereby comprising the negative geometry of the personalized device, and
at least one separation plane and/or separation spline defining the sectioning of the casting mold CAD model.
